(19) United States
(12) Patent Application Publication
(10) Pub. No.: US 2005/0281239 A1
(43) Pub. Date: Dec. 22, 2005

(54) System and method for signaling modes

(75) Inventor: Richard G. C. Williams, Santa Rosa, CA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/112,490

(22) Filed: Apr. 22, 2005

Related U.S. Application Data
(60) Provisional application No. 60/582,356, filed on Jun. 22, 2004.

(51) Int. Cl. H04J 1/00

(52) U.S. Cl. 370/343

(57) ABSTRACT

A wireless communication device 100 is disclosed. The wireless communication device 100 consists of a transmitter 110 that can transmit an OFDM signal based on a format prescribing at least one field. The transmitter 110 can transmit at least one of the prescribed fields with data other than the data prescribed for the prescribed field.

### CROSS-REFERENCE TO RELATED APPLICATIONS

This application claims priority to U.S. Provisional Application No. 60/582,356 filed Jun. 22, 2004, and entitled “System and Method for Signaling WLAN Modes,” by Richard G. C. Williams, which is incorporated herein by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure is directed to data communication, and more particularly, but not by way of limitation, to a system and method for signaling transmission modes in wireless network transmissions.

### BACKGROUND OF THE INVENTION

Wireless data transmissions may be structured as packets containing the information to be conveyed as well as metadata such as the data packet length, the data transmission rate, and the communication means. The metadata may be contained in a portion of a packet referred to as the SIGNAL field. A transmitter may transmit the packets to a plurality of wireless receivers in a wireless local area network. Each receiver may decode the metadata in the SIGNAL field to determine how the packet is to be processed.

### SUMMARY OF THE INVENTION

In one embodiment, a wireless communication device is provided. The wireless communication device consists of a transmitter that can transmit an OFDM signal based on a format prescribing at least one field. The transmitter can transmit at least one of the prescribed fields with data other than the data prescribed for the prescribed field.

In another embodiment, a system for communication is provided. The system consists of a transceiver, a first component, and a second component. The transceiver can transmit and receive OFDM signals. The first component can encode data for transmission by the transceiver. The data is based on a format prescribing a prescribed field, and the first component can encode the prescribed field with data other than the data prescribed for the prescribed field. The second component can identify data received from the transceiver as based on a second format where the data in the prescribed field is other than the prescribed data for the prescribed field.

In another embodiment, a method for communicating an orthogonal frequency division multiplex (OFDM) signal to indicate a change in modes is provided. The method consists of generating an OFDM signal based on a mode prescribing at least one field, and encoding at least one of the prescribed fields with data other than the data prescribed for the prescribed field to indicate a change to the mode.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a diagram of pilot tones in a data packet according to the prior art.

FIG. 2 is a diagram of pilot tones in a data packet according to an embodiment of the disclosure.

FIG. 3 is an illustration of components in the transmission of a data packet according to an embodiment of the disclosure.

FIG. 4 is an illustration of a method for transmitting a data packet according to an embodiment of the disclosure.

### DETAILED DESCRIPTION OF THE PREFERRED EMBODIMENTS

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein.

The Institute of Electrical and Electronics Engineers (IEEE) publishes several standards regarding data communications in wireless local area networks (WLANs). Some of the standards use orthogonal frequency division multiplexing (OFDM) for transmitting data. An OFDM data packet can consist of a series of data components known as OFDM symbols. One of the OFDM symbols can be a SIGNAL field containing information that allows WLAN devices to determine the characteristics of the OFDM transmission and process the OFDM transmission appropriately. Details about the format of a typical OFDM transmission can be found in U.S. patent application Ser. No. 10/911,843, filed Aug. 5, 2004, and entitled “Method of Signaling the Length of OFDM WLAN Packets,” which is incorporated herein by reference for all purposes.

Current OFDM data transmissions have packet formats that are recognizable by current WLAN devices. Future WLAN devices might use packet formats that are different from the current formats. It is desirable that future data communications have a format that allows transmissions to newer devices to be distinguished from transmissions to legacy devices. For example, the emerging IEEE 802.11n WLAN standard will use a different signaling format to transfer information but will have to coexist with existing WLAN equipment. Simultaneously, such transmissions must be understood in part by legacy devices so that the legacy devices know when they are allowed to access the wireless medium. This can be achieved by sending enough information to a legacy device so that the legacy device understands that a WLAN packet of a certain length has begun. The legacy device could then remain silent for the duration of the packet even though the legacy device would be unable to decode the contents of the packet.

The present disclosure, according to one embodiment, provides a system and method for modifying the SIGNAL field of an OFDM transmission to indicate whether the transmission is intended for a legacy device or a newer device. A newer device can recognize that a packet is following a new transmission mode and that the newer device is the intended recipient of the transmission. The device can then read the data in the transmission. A legacy device can determine the length of the transmission and remain silent throughout the transmission even though the legacy device is unable to decode the data content of the transmission.

The IEEE 802.11a and 802.11g standards specify that the SIGNAL field of an OFDM transmission contain 52 subcarriers or tones. Forty-eight of these tones are used for data that is to be conveyed from the transmitter to the receiver. The other four tones are pilot tones that are used to initialize a sequence of pilot tones that synchronize the transmission between the transmitter and the receiver. When the oscillators in the transmitter and the receiver do not oscillate at the exact same frequency, the subcarriers can interfere with each other and cause errors in the data transmission. To prevent this, the four pilot tones are given specified data and are placed in specified locations in each SIGNAL field and subsequent OFDM symbol. By examining the locations of the pilot tones, the transmitter and receiver can determine any frequency offset that exists between them and make the appropriate adjustments so that the transmissions are synchronized.

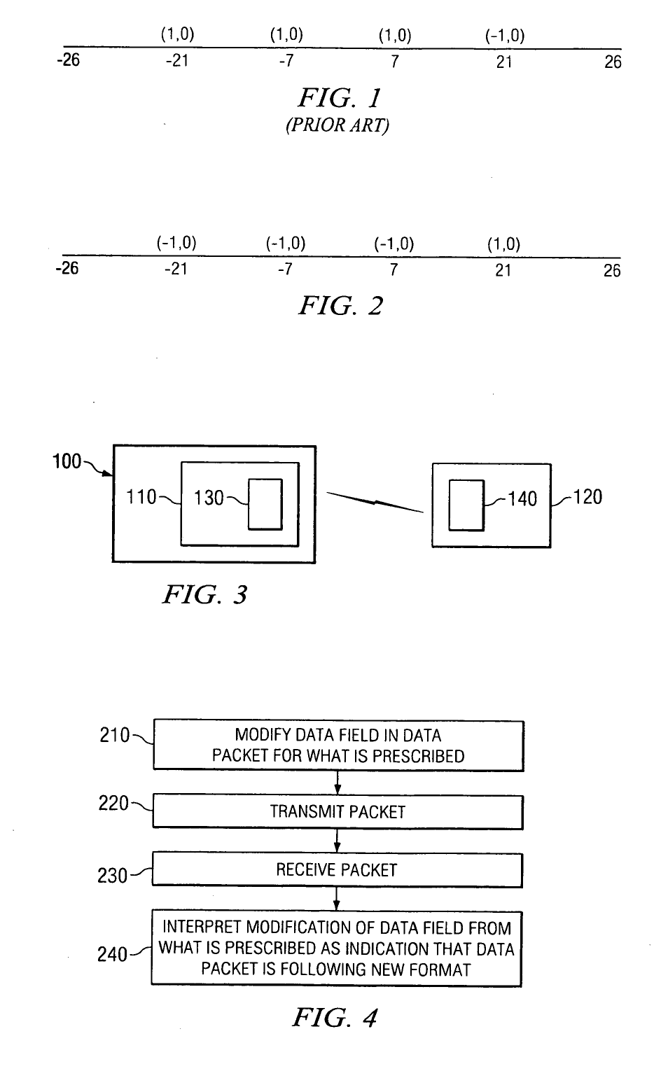

FIG. 1 illustrates the pilot tones as specified for the SIGNAL field by IEEE standards 802.11a and 802.11g. In this case, the 52 tones are shown at locations ranging from −26 to +26 (0 is not used). The pilot tones are placed at locations −21, −7, +7, and +21, and have the values (1,0), (1,0), (1,0), and (−1,0), respectively.

In one embodiment of the present disclosure, the polarity of the data in one or more of the pilot tones is reversed as compared to the specifications of the IEEE 802.11a and 802.11g standards. The polarity reversal indicates to newer devices that a packet is following a new transmission mode. This is illustrated in FIG. 2, where the pilot tones are again at locations −21, −7, +7, and +21, but now have the values (−1,0), (−1,0), (−1,0), and (1,0), respectively.

In this embodiment, the polarity of all the pilot tones has been reversed, but this does not necessarily need to be the case. Reversing the polarity of any one pilot tone or any combination of more than one pilot tone would be sufficient to indicate that a transmission is intended for a newer device. Indeed, any alteration of the data carried on a pilot tone can be used. Reversing the polarity will lead to the most robust differentiation at the receiver but this is not the only perturbation that can be used. For instance, a 90 degree rotation of each pilot by using the values (0,1), (0,1), (0,1), (0,−1) could also be used, as could rotating the pilots by 72, 144, 216, and 288 degrees, or other rotations.

In a preferred embodiment, the polarity of the pilot tones is reversed only for transmissions sent to newer devices in the presence of legacy devices; transmissions exclusively to legacy devices may follow the standard format. The newer devices will recognize that the polarity reversal indicates that the data transmission is following a new format and will interpret the transmission appropriately. Legacy devices will also recognize a SIGNAL field with reversed polarity pilot tones and be able to decode the metadata contained within the SIGNAL field including the length of the transmission. A suitable method for determining the length of the transmission can be found in U.S. patent application Ser. No. 10/911,843, which is incorporated by reference above.

Since modifying the data content of the pilot tones will interfere with the initialization of the pilot tone sequence, legacy devices will have degraded synchronization capabilities. However, since a data transmission with altered pilot tones in the SIGNAL field would not be intended for a legacy device and could not be decoded by a legacy device, the degradation of synchronization capabilities for legacy devices is irrelevant. New devices will be aware of the different possible pilot tone values and will be able to initialize their synchronization circuits appropriately.

In various embodiments, different combinations of values in the pilot tones can convey different information. When using just polarity reversal with four pilot tones, there are 16 different combinations of polarities in the pilot tones. One combination is used for the prescribed polarities of (1,0), (1,0), (1,0), and (−1,0), leaving 15 other combinations available to indicate that a data transmission is following a newer format and is intended for a newer device. Any or all of these 15 combinations could also be used to convey additional information.

For instance, one piece of metadata that will be transferred in the emerging 802.11n standard is the number of transmit antennas. Different pilot polarity patterns could indicate different numbers of transmit antennas. As an example, one, two, three, or four transmit antennas could be signaled by the pilot sets (−−−−), (++−−), (−−++), or (+−+−), respectively, where “−” indicates a polarity reversal. Alternatively, one, two, three, or four transmit antennas could be signaled by rotating the pilots by 72, 144, 216, and 288 degrees.

The robustness of the differentiation of pilot tone values at the receiver is proportional to the Euclidean distance between the values being differentiated. Thus, when constructing patterns to send that will be differentiated and so convey extra information, the set of values should be a set that maximizes the Euclidean distance between any pair of sets of values.

While the above discussion has focused on OFDM transmissions in WLANs, one of skill in the art will recognize that similar concepts could be used for OFDM transmissions in other circumstances. For example, digital subscriber line (DSL) transmissions, digital video broadcast (DVB) transmissions, and other types of transmissions that use OFDM could employ similar techniques to indicate that a non-legacy transmission is being sent.

Also, the above discussion has focused on pilot tones in the SIGNAL field portion of an OFDM transmission, but pilot tones are also present in the data portion of an OFDM transmission. The value of one or more of the pilot tones in the data portion could also be changed to indicate that a new type of transmission is being sent. More broadly, any prescribed data in a data transmission that can be modified without loss of the information to be conveyed in the transmission could be altered to indicate the format of the transmission.

As an example, a legacy device might support a lower data transmission rate and a newer device might support a higher data transmission rate. It might be desired to send data at the lower transmission rate to all the devices in a WLAN and then send data at the higher transmission rate only to the newer devices in the WLAN. Some combination of polarities in the pilot tones could be used in an OFDM symbol in the midst of a transmission to indicate that the data transmission rate is changing. Newer devices would change modulation format upon seeing a particular combination of polarities in the pilot tones, whereas legacy devices would not be able to decode the final symbols of the transmission. Changing the polarities of the pilot tones in any OFDM symbol can be used as an indicator to devices that are able to detect the change. Other uses for the different combinations of values in the pilot tones will readily suggest themselves to one skilled in the art and are within the spirit and scope of the present disclosure.

FIG. 3 illustrates an embodiment of the components that might be used in transmitting a data packet. A device 100 is shown that includes a transmitter 110, which may be a transceiver, to transmit a data packet to another device having a receiver 120. The transmission might be a WLAN transmission, a DVB transmission, a DSL transmission, or some other wireless transmission. The transmitter 110 contains an encoding component 130 that can place data in a prescribed data field in the data packet that is different from the data that is prescribed for the prescribed data field. The receiver 120 contains a decoding component 140 that can recognize that the prescribed data field contains data that is different from the data that is prescribed for the prescribed data field. The decoding component 140 can interpret the fact that the prescribed data field contains data that is different from the data that is prescribed for the prescribed data field as an indication that the data packet is following a new format.

The transmitter 110 might perform only transmission functions and the receiver 120 might perform only reception functions, or the transmitter 110 and the receiver 120 might be transceivers that can perform both transmission and reception. Similarly, the encoder 130 might perform only encoding functions and the decoder 140 might perform only decoding functions, but in some embodiments these components may perform both encoding and decoding functions. The encoding and decoding functions might be performed by discrete components within or coupled to the transmitter 110 and/or the receiver 120, or the encoding and decoding components might be wholly or partially integrated with the transmitting and receiving components. Other arrangements and combinations of the encoding, decoding, transmitting, and receiving functions will readily suggest themselves to one skilled in the art and are within the spirit and scope of the present disclosure.

FIG. 4 summarizes the steps that might be taken in communicating a data packet. In box 210, a data field in the data packet is modified from what is prescribed in a wireless transmission standard. In box 220, the data packet is transmitted. In box 230, the data packet is received. In box 240, the modification of the data field from what is prescribed is interpreted as an indication that the data packet is following a new format.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

1. A wireless communication device, comprising:
a transmitter operable to transmit an OFDM signal based on a format prescribing at least one field, the transmitter further operable to transmit at least one of the prescribed fields with data other than the data prescribed for the prescribed field.

2. The wireless communication device of claim 1, wherein the prescribed field is a pilot tone.

3. The wireless communication device of claim 2, wherein the difference between the data transmitted and the prescribed data is a reversal of polarity of the pilot tone.

4. The wireless communication device of claim 2, wherein the pilot tone is in a SIGNAL field portion of the signal.

5. The wireless communication device of claim 2, wherein the pilot tone is in a data field portion of the signal.

6. The wireless communication device of claim 1, wherein the transmitter is further operable to selectively transmit the prescribed data in the prescribed field when communicating with legacy devices, the legacy devices inoperable for communication in a second format indicated by the transmission of data other than the data prescribed for the prescribed field.

7. The wireless communication device of claim 2, wherein the transmitter is further operable to transmit data other than the data prescribed by the format for more than one pilot tone and wherein changes to prescribed data for more than one pilot tone convey information in addition to indicating that the OFDM signal is based on a second format.

8. A system for communication, comprising:
a transceiver operable to transmit and receive OFDM signals;
a first component to encode data for transmission by the transceiver, the data based on a format prescribing at least one field, the first component operable to encode at least one of the prescribed fields with data other than the data prescribed for the prescribed field; and
a second component operable to identify data received from the transceiver as based on a second format where the data in at least one of the prescribed fields is other than the prescribed data for the at least one of the prescribed fields.

9. The system of claim 8, wherein the transceiver is operable for OFDM communication according to IEEE standards 802.11a, 802.11g, and 802.11n.

10. The system of claim 8, wherein the prescribed field is a pilot tone.

11. The system of claim 8, wherein the prescribed fields are further defined as pilot tones according to an 802.11a IEEE standard at locations −21, −7, +7, and +21, and have values of (1,0), (1,0), (1,0), and (−1,0), respectively.

12. The system of claim 11, wherein the polarity of one or more of the pilot tones is changed to indicate the second format.

13. The system of claim 11, wherein first component is operable to change the data to other than the prescribed data in a plurality of the prescribed fields, and wherein the second component identifies the changed data to indicate the second format and further to indicate additional information.

14. The system of claim 8, wherein the transmission is selected from a group of transmissions consisting of a digital subscriber line (DSL) transmission and a digital video broadcast (DVB) transmission.

15. A method for communicating an orthogonal frequency division multiplex (OFDM) signal to indicate a change in modes, comprising:
generating an OFDM signal based on a mode prescribing at least one field; and
encoding at least one of the prescribed fields with data other than the data prescribed for the prescribed field to indicate a change to the mode.

16. The method of claim 15, wherein the prescribed field is a pilot tone defined by an IEEE standard.

17. The method of claim 16, wherein the modification to the prescribed field is a reversal of polarity of the pilot tone.

18. The method of claim 17, wherein the modified pilot tone is selected from one of a SIGNAL field portion and a data field portion of the data packet.

19. The method of claim 16, wherein more than one pilot tone is modified and wherein modifications to the more than one pilot tone convey information in addition to indicating the change to the mode.

20. The method of claim 15, further comprising:
selectively encoding and transmitting the OFDM signal having the prescribed data in the prescribed field when communicating with legacy devices, the legacy devices inoperable for communication in a second mode indicated by the transmission of data other than the data prescribed for the prescribed field.
